(19) United States
(12) Patent Application Publication
(10) Pub. No.: US 2006/0175008 A1
(43) Pub. Date: Aug. 10, 2006

(54) Crosslinkable hotmelt mixture and process for coating and/or lamination of substrates

(76) Inventors: Bernhard Goossens, Weeze (DE); Holger Jahn, Krefeld (DE); Ingo Notz, Kreferd (DE)

Correspondence Address: PERMAN & GREEN, 425 POST ROAD, FAIRFIELD, CT, 06824, US

(21) Appl. No.: 11/127,050

(22) Filed: May 11, 2005

(30) Foreign Application Priority Data
Feb. 10, 2005 (DE) 10 2005 006 335.7

(51) Int. Cl. C08F 290/14

(52) U.S. Cl. 156/327; 525/50

(57) ABSTRACT

A process and a composition for the production of crosslinkable hotmelts for the coating and/or lamination (bonding) of substrates are described, whereby the hotmelt is an amine-terminated copolyamide and the crosslinker belongs to the class of multifunctional acrylates and/or multifunctional acrylamides.

Subject of the invention is a process for the production of a crosslinkable hotmelt adhesive coating on the basis of an aqueous paste, consisting of a usual amine-terminated copolyamide and a crosslinker from the class of trifunctional acrylamides for screen-printing of, for example, fusable interlinings for the garment industry (paste dot process).

Subject of the invention is further a process for the production of a crosslinkable hotmelt adhesive coating (double dot process) on the basis of an aqueous dispersion, consisting of a usual amine-terminated copolyamide and a crosslinker from the class of trifunctional acrylates for screen-printing (base point) of, for example, fusible interlinings for the garment industry, which after coating is covered with a hotmelt adhesive powder or a mixture of hotmelt adhesive and crosslinker (top point) and upon drying yields a crosslinked base point.

Subject of the invention is furthermore a powder mixture, consisting of an amine-terminated copoyamide and a crosslinker belonging to the class of trifunctional acrylamides, which according to the present invention is used as cover material for the top point in the double dot process and which is used as coating material in the powder dot process.

The use of hotmelts for solvent-free coating (hotmelt application, powder dot process) or the use of aqueous hotmelt dispersions in screen-printing (paste dot process, double dot process) for bonding rigid or flexible substrates is state of the art.

Laminates, which are produced using usual hotmelt adhesives on the basis of copolyamides or copolyesters as well as their coating systems maintain their thermoplasticity after bonding. They are negatively influenced by temperature, mechanical stress or solvents. This may even cause delamination.

It is known that thermoplasticity and solubility of hotmelt adhesive bondings can be reduced or eliminated by crosslinking: moisture curable isocyanate- or silane crosslinkers yield three-dimensional, non-meltable polymers; it is of disadvantage that these systems must be stored under exclusion of moisture until use.

Hotmelt adhesives with hydroxy-functionalities or amino-functionalities can also be crosslinked with blocked isocyanates, because however the deblocking temperature exceeds 140° C. and fast bonding processes would require even higher temperatures, the use of heat-sensible substrates is excluded.

Pros and Contras of such modified hotmelt adhesives are described in literature and known to those skilled in the art.

EP 0598873 provides a solution for hotmelt application by extruding separate layers of hydroxy- or amine-terminated hotmelt adhesives and surface-deactivated isocyanates, however the described mixture can not be used as fine powder of 1-80μ particle size necessary for water based dispersions for sreen-printing, because the isocyanate is fully deactivated by water. Furthermore, the productions requires complex extrusion facilities.

It was therefore an object of the present invention, to provide hotmelt adhesive systems, which are applied onto a given substrate as a water-based dispersion in the course of paste dot process, which maintain their latent reactivtity under usual drying temperatures and which are only irreversibly crosslinked subsequently upon further increase of temperature (final lamination, bonding).

Surprisingly it was now found that aqueous dispersions of amine-terminated copolyamides and multifunctional acrylamide-crosslinkers, for example, TATHT (Trisacrylamidotrihydrotriazine), do not react spontaneously with each other and that even at elevated temperatures (for example 110° C.), which are e.g. required for technical drying of a printed paste, no addition takes place.

The final addition (=crosslinking) was only accomplished at lamination temperatures of 130° C. and higher.

The laminates obtained according to the present invention exhibit a significantly higher stability against hydrolysis and resistance against solvents as well as a higher thermostability than laminates produced without the addition of the inventively used crosslinker type.

A further object of the present invention was to provide hotmelt adhesive systems, which in the course of the double dot process on one hand deliver an effective barrier and on the other hand are cross-linked upon final lamination to acheive reduced/eliminated thermoplasticity and improved washing stability and resistance against solvents.

EP 1197541A1 describes the use of micro-encapsulated polyisocyanate dispersions in combination with amine-terminated copolyamides or copolyesters for the formation of an effective barrier on the basis of aqueous dispersions. The production of micro-encapsulated polyisocyanate dispersions however is complex and expensive. A system for the final crosslinking of the top dots is not mentioned.

Surprisingly it was found that multifunctional acrylic acid esters, for example, ethoxilated trimethylolpropane triacrylate, in combination with amine-terminated copolyamides applied as aqueous dispersions do generate effective barriers by selective crosslinking during the drying process (bottom dots) and the addition of powder mixtures of amine-terminated copolyamides and multifunctional acrylamides, for example TATHT (Trisacrylamidotrihydrotriazine) as top dots do yield a bonding system, which only crosslinks at final fusing/laminating temperatures of 130° C. and higher.

A further object of the present invention was to provide a composition that, upon being applied by means of powder dot technology, delivers a crosslinkable adhesive system, which maintains its latent reactivity during the technical process of slight surfacial melting of the hotmelt and which only fully crosslinks at the final lamination temperature.

It was now found that compostions consisting of TATHT (Trisacrylamidotrihydrotriazine) as crosslinker and amine-terminated copolyamides in the melting range of 90°-150° C. as hotmelts do meet these requirements, if the time dependent heat application to the powder dot causes only a slight surfacial melting of the powder dot and the final bonding/lamination temperature exceeds the melting temperature of the hotmelt adhesive.

Subject of the present invention is further a hotmelt adhesive mixture, which upon heating to a temperature corresponding at least to the melting temperature or the melting temperature range of its hotmelt adhesive component and/or its crosslinker component is almost completely crosslinkable.

In the following the present invention is illustrated by examples.

These examples have only the purpose of illustrating the invention and do not limit the general idea of the invention.

### EXAMPLES

### Example 1

### Paste Dot Process

An amine-terminated copolyamide (e.g. 1-80 micron, melting range 85-135° C., meltviscosity 10-100 g/10 min at 140° C., mval amine/kg 100-800) and TATHT (Trisacrylamidotrihydrtriazine) were formulated with usual dispersing agents and thickeners as described, for example, in DE-B 2007971, DE-B 2229308, DE-B 2407505 and DE-B 2507504 to yield a printable paste, which was printed with usual rotating screens onto nonwoven (PET/PA-blend of a square weight of approximately 25 g/m²) with an uptake of 7-12 g/m² dry matter. After drying the printed nonwoven at 110° C. and storing of the printed nonwoven at room temperature for a week, it was thermobonded to an acetate-fabric at 140° C. (15 sec, 4N/cm²). The resulting laminate was subjected to a washing procedure at 60° C. and to a chemical cleaning process and the bonding strength of the laminate determined subsequently.

Results:

primary adhesion: nonwoven tom off

60° C. washing: nonwoven torn off

chem.cleaning: nonwoven tom off

Comparison Experiment 1:

An analogeous paste according to the state of the art like example 1 but without the addition of the crosslinker TATHT, yielded after fixation under identical conditions:

primary adhesion: nonwoven torn off

60° C. washing: delamination

chem.cleaning: delamination

### Example 2

### Double Dot Process

An amine-terminated copolyamide according to example 1 was formulated with usual dispersing agents and thickeners as described in example 1 under addition of ethoxilated trimethylolpropane triacrylate to yield a printable paste and printed on a rotary-screen printing machine with a, for example, CP 66 screen onto a relatively open HB-texturized knitted polyester-fabric (square weight 33 g/cm²). The resulting, still wet paste dots (uptake dry 3 g/m², invention related bottom dots) were sprinkled with 1.) pure amine-terminated copolyamide powder—comparative top dot—and 2.) with a powder mixture of amine-terminated copolyamide and TATHT (invention related top dot). After sucking off the excess of powder the wet bottom dots were dried in the drying zone at 125° C. and surfacial melted. The uptake of the top dots was in both cases 6 g/m². After 1 week storage at room temperature the coated knitted fabrics were thermobonded at 140° C. (15 sec, 4 N/cm²) to an acetate-fabric and the laminate subjected to a 60° C. washing and dry cleaning.

An analogous trial was carried out without crosslinker in the bottom dot. Subsequently the bonding strength of the laminate was determined.

The strike through was rated manually by a scale of 1 (no adhesion to a test fabric) to 6 (full strike through).

Results:

Bottom dot without crosslinker/top dot without crosslinker

primary adhesion: 16N/5 cm

washing 60° C.: 6N/5 cm

chem.cleaning: delamination

strike through: 5

Bottom dot with crosslinker according to the present invention/top dot without crosslinker:

primary adhesion: 18N/5 cm

washing 60° C.: 9N/5 cm

chem.cleaning: 3.5N/5 cm

strike through: 1

Bottom dot without crosslinker/top dot with crosslinker according to the present invention:

primary adhesion: 18N/5 cm

washing 60° C.: 17N/5 cm

chem.cleaning: 14N/5 cm

strike through: 4

bottom dot with crosslinker according to the present invention/top dot with crosslinker according to the present invention:

primary adhesion: 20N/5 cm

washing 60° C.: 19N/5 cm

chem.cleaning: 18N/5 cm

strike through: 1

### Example 3

### Powder Dot Process

A powder mixture consisting of amine-terminated copolyamide and TATHT was applied to a PET fabric (square weight 45 g/m²) with an engraved roller CP 66 (10 g/m²), the surface slightly molten at 125° C. and subsequently fixed to a wool/polyester blend at 4N linear pressure.

The resulting laminate was subjected to a washing procedure at 60° C. and to a chemical cleaning, the bonding strength of the laminate was determined subsequently.

Results:

Primary adhesion: 22N/5 cm

Washing 60° C. :21N/5 cm

Chem.cleaning: 20N/5 cm

A comparative trial without addition of the invention related crosslinker yielded:

Primary adhesion: 22N/5 cm

Washing 60 C: 8N/5 cm

Chem.cleaning: 12N/5 cm

1. A crosslinkable hotmelt adhesive comprising
(a) at least one amine-terminated copolyamide and/or at least one hydroxy-terminated copolyester as hotmelt component, and
(b) at least one multifunctional acrylate and/or at least one multifunctional acrylamide as crosslinking component.

2. A crosslinkable hotmelt adhesive mixture according to claim 1, characterized in that component (a) is an amine-terminated copolyamide with a melting range of 90-150° C.

3. A crosslinkable hotmelt adhesive mixture according to claim 1, characterized in that component (b) is a multifunctional acrylamide with more than two reactive groups per molecule, preferably a multifunctional acrylamide with more than two activated double bonds per molecule.

4. A crosslinkable hotmelt adhesive mixture according to claim 1, characterized in that component (b) is Trisacrylamido-trihydrotriazine (TATHT).

5. A crosslinkable hotmelt adhesive mixture according to claim 1, characterized in that it is in form of a water-based dispersion, a water-based paste or in form of a power.

6. A process for coating of substrates, preferably textile substrates, characterized in that a crosslinkable hotmelt adhesive mixture according to claim 1 is applied to the substrate, whereby the components of said mixture may be applied simultaneously or sucessively.

7. A process according to claim 6, characterized in that the application is carried out via the paste dot process.

8. A process according to claim 6, characterized in that the application is carried out via the double dot process.

9. A process according to claim 8, characterized in that the crosslinkable hotmelt mixture is applied as bottom dot.

10. A process according to claim 8, characterized n that the crosslinkable hotmelt mixture is applied as top dot.

11. A process according to claim 6, characterized in that the application is carried out via the powder dot process.

12. A process for lamination of substrates, preferably textile substrates, comprising
(a1) coating of at least one first substrate with a crosslinkable hotmelt adhesive mixture according to claim 1, and
(a2) laminating the substrate obtained according to step (a1) to at least one second substrate at a temperature which is at least sufficiently high to achieve nearly complete crosslinking.

13. A process according to clam 12, characterized in that the temperature corresponds at least to the melting point or melting range of at least one of the components (a) and/or (b), preferably (a), of the crosslinkable hot melt adhesive mixture.

14. A substrate, preferably a textile substrate, coated with a cross-linkable hotmelt adhesive mixture according to claim 1.
